(19) United States
(12) Patent Application Publication
(10) Pub. No.: US 2017/0197518 A1
(43) Pub. Date: Jul. 13, 2017

(54) Recovering Braking Energy Via Dynamic Mobile Wireless Power Transfer

(71) Applicant: Ford Global Technologies, LLC, Dearborn, MI (US)

(72) Inventors: Scott Vincent Myers, Camarillo, CA (US); Venkatapathi Raju Nallapa, Fairfield, CA (US); Fazal Urrahman Syed, Canton, MI (US); Michael Edward Loftus, Northville, MI (US)

(21) Appl. No.: 14/993,884

(22) Filed: Jan. 12, 2016

(51) Int. Cl. B60L 11/18; B60L 7/10

(52) U.S. Cl. CPC B60L 11/1842; B60L 11/1837; B60L 11/182; B60L 7/10; B60Y 2300/18125; B60Y 2300/91; B60L 2230/10

(57) ABSTRACT

Systems and methods for recovering brake energy via dynamic wireless power transfer. The system may include a first charging pad disposed at a first location of a road structure and configured to receive an electric power wirelessly from a contributing vehicle. The system may further include a second charging pad disposed at a second location of the road structure and configured to receive the electric power from the first charging pad and charge a receiving vehicle wirelessly with at least a portion of the electric power.

### TECHNICAL FIELD

The present disclosure generally relates to regenerative energy and, more particularly, to methods and systems for recovering braking energy via dynamic mobile wireless power transfer.

### BACKGROUND

Viewed as a whole, a group of vehicles driving on the road are wasting much energy due to individual acceleration and deceleration operations. In an acceleration operation, a vehicle often requires energy to increase its speed, be it a fuel-powered, electricity-powered or hybrid vehicle. On the other hand, a vehicle also consumes energy in a deceleration operation. When a vehicle decelerates, it consumes energy by losing its kinetic energy through friction provided by a braking system of the vehicle. The unwanted kinetic energy is thus “wasted” primarily in the form of dissipated heat.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a diagram depicting an example system in accordance with an embodiment of the present disclosure.

FIG. 2 is a diagram depicting an example system in accordance with another embodiment of the present disclosure.

FIG. 3 is a diagram depicting an example system in accordance with yet another embodiment of the present disclosure.

FIG. 4 is a diagram depicting an example system in accordance with still another embodiment of the present disclosure.

FIG. 5 is a diagram depicting an example system in accordance with an additional embodiment of the present disclosure.

FIG. 6 is a diagram depicting an example system in accordance with a further embodiment of the present disclosure.

FIG. 7 is a flowchart of an example process in accordance with an embodiment of the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

As stated previously, a vehicle consumes energy in both acceleration and deceleration operations. In particular, when a vehicle decelerates, much energy is wasted due to the unwanted kinetic energy of the vehicle being dissipated as heat through friction provided by the braking system of the vehicle. It therefore follows logically that, there would not be so much energy wasted if the unwanted energy during the deceleration process of a vehicle can be somehow “recouped” or otherwise harnessed, and advantageously transferred to a nearby vehicle that requires power to perform an acceleration operation. That is, according to embodiments of the present disclosure, energy dissipated by one vehicle may be harnessed and stored, and eventually used to charge another vehicle. In this way, the energy is optimally distributed between the vehicles when viewed as a whole.

The present disclosure promotes a mechanism or scheme in which the unwanted kinetic energy during the deceleration process is recouped or otherwise harnessed by a regenerative braking apparatus equipped in the vehicle. The regenerative braking apparatus, when engaged, converts at least part of the kinetic energy of the vehicle to another form, usually in the form of electric power. The regenerative braking apparatus is readily applicable to a vehicle powered, at least partially, by electricity, such as an electric vehicle (EV) or a hybrid electric vehicle (HEV). During the deceleration process, the unwanted kinetic energy of the vehicle can thus be converted, at least partially, by the regenerative braking apparatus to electric power, and saved in a battery of the vehicle. The harnessed electric power, or electric energy, is thus available to be used by the vehicle in a next operation that demands power, such as a following acceleration operation.

Although a regenerative braking apparatus is mostly applicable to EVs and HEVs, it is not limited to be equipped to and utilized by such vehicles only. Rather, a regenerative braking apparatus can be equipped to and utilized by a conventional, non-electric-powered vehicle as well. Additionally, as an example, a work truck powered by a diesel engine may carry on it some equipment that demands much electricity, such as an electric towing crane, and the electricity can be provided by a regenerative braking apparatus equipped thereon. As another example, a fire truck or a police car is surely to consume lots of electric power for its loud sirens and bright flashing lights, and thus can utilize the electric power recouped by a regenerative braking apparatus if it is available.

A readily recognized limitation of such a scenario of recovering and utilizing braking energy is that there is only certain capacity for the battery equipped in the vehicle, or “on board”. The on-board battery has a certain capacity, and it is obvious that the braking energy cannot be recovered and recouped beyond the capacity of the on-board battery. Once the on-board battery is full, the unwanted kinetic energy of the vehicle cannot be further recovered and stored even if the regenerative braking apparatus is engaged. Consequently, the kinetic energy is still to be lost and wasted.

Another limitation of the scenario mentioned above resides in that a conventional fuel-powered sedan or car in typical daily use will not take part of this energy efficient approach, and thus the unwanted kinetic energy during a deceleration operation would be totally wasted as dissipated heat and vibration. That is, even if equipped a regenerative braking apparatus, such a car would not have a place for the kinetic energy recouped during a deceleration operation to go. Besides, even with the head lights and car radio accounted for, there is little demand of electricity for such a car, and the demand of electricity is already readily supplied by its small-capacity on-board battery.

With these limitations recognized, the present disclosure is to further advocate a use of a wireless power transfer to dynamically transfer the recovered electric power via the regenerative braking apparatus out of the vehicle. That is, through the wireless power transfer, a vehicle can wirelessly transfer, at least partially, the recovered electric power to a destination, a storage or a receiving object located outside the vehicle. The wirelessly transferred electric energy can subsequently be utilized by the receiving object, or simply stored in the storage for later use by another object demanding electric power. In this scenario with dynamic wireless power transfer, the aforementioned limitations are lifted, and a power recovering and reutilizing system is thus formed between the vehicle that transfers the electric power out of itself (i.e., the “contributing vehicle”) and the other object that demands electric power. In some embodiments, the other object that demands electric power is another vehicle (i.e., the “receiving vehicle”).

In some embodiments, the storage can be a battery or an electrical capacitor located outside both the contributing vehicle and the receiving vehicle. As the power storage is located outside a vehicle, mostly likely located in the vicinity of the place where the energy recovery takes place, the capacity of the storage can be greatly increased. With a sufficiently large capacity for storing the recovered energy, essentially unlimited amount of brake energy can be recovered and stored in a form of electric power for later use. It is to note that the power storage is advantageously disposed close to the contributing vehicle and the receiving vehicle so as to avoid transmission loss of a significant portion of the recovered brake energy over otherwise long distance power line transmission.

In some embodiments, there may not be the storage included in the power recovering and reutilizing system, in which case the recouped energy is readily sent to the receiving vehicle and being used (i.e., “charges” the receiving vehicle). In some embodiments where a battery and/or a capacitor is included as the storage media, the receiving vehicle may be the same as the contributing vehicle. Namely, a vehicle may wirelessly transfer the recovered braking energy in the form of electricity to the storage media to be saved, and then the storage media will, at a later time, charge the same vehicle by wirelessly transferring back the recovered braking energy to the vehicle.

In some embodiments, the wireless power transfer or charging operations, as disclosed above, may be implemented or realized by using so-called “inductive power transfer”. A charging pad that includes inductive coils may be placed on, buried under or embedded in the surface of a local road structure. When a vehicle equipped with a regenerative braking apparatus drives on or near the charging pad, electric power transfer can be configured to take place between the charging pad and the vehicle. The direction of the energy transfer can be configured as desired, either from the vehicle to the charging pad (in the case where the vehicle is a contributing vehicle) or from the charging pad to the vehicle (in the case where the vehicle is a receiving vehicle). The inductive power transfer is a non-contact power transfer that may work over a distance between a power source and a receiving party. Therefore a vehicle needs not to be in contact with a charging vehicle for the inductive power transfer to take place. That is, the wireless power transfer advocated by the present disclosure is “dynamic” in nature, where a vehicle is free to move and charge (i.e., transfer electric power to) or discharge (i.e., transfer electric power from) various charging pads as the vehicle moves passing by them or runs near them. Another nature of the inductive power transfer is that the transfer efficiency may not be 100%. That is, a contributing vehicle may be able to transfer only a part of the recovered electric energy to a charging pad. By the same token, a charging pad may be able to transfer only a part of the electric energy available to a receiving vehicle.

It is to note that, for the same reason as for the energy storage previously mentioned, the charging pads are also advantageously disposed close to the contributing vehicle and the receiving vehicle so as to avoid transmission loss of a significant portion of the recovered brake energy over otherwise long distance power line transmission. Preferably, the charging pads and the energy storage media, if any, are located within or in the vicinity of a local road structure, such as a highway access, an underpass, an overpass, a two-way road section located on a slope, a road section having a dip, a stop sign, a toll booth or a bus stop, a road section having a turn, a highway cloverleaf interchange or a surface roundabout circular intersection.

It is also worth noting that, the employment of off-vehicle storage batteries in conjunction with dynamic wireless power transfer opens up a new category of sources for regenerative power, namely, the fuel-powered heavy-load cargo trucks, commercial trucks, recreational vehicles (RVs) and the like. With its heavy mass, a vehicle in this category carries a massive amount of kinetic energy as compared to a typical sedan. But that also means a huge amount of kinetic energy is left to be wasted and dissipated as heat in a deceleration operation, unless it is equipped with a regenerative braking apparatus. However, there is little incentive for these heavy-load vehicles to include a regenerative braking apparatus, for the huge mass of the vehicles essentially prevents them from using electric power as even part of the source of their driving power. Consequently, the huge amount of kinetic energy in a deceleration operation is not recouped and reutilized. Thanks to the off-vehicle storage batteries in conjunction with dynamic wireless power transfer, both advocated in the present disclosure, the heavy-load trucks and similar vehicles are provided with feasible and practical way to recoup their huge amount of brake energy. This provides a new category of sources for regenerative power to benefit other vehicles and objects that demands power. For example, such an energy recovery system can be implemented at a UPS or FedEx cargo truck facility located close to a highway access, and the recovered brake energy from the hundreds of heavy-load trucks coming down from the exit ramp of the highway access every day may very well be sufficient to cover the daily utility electricity usage of the facility.

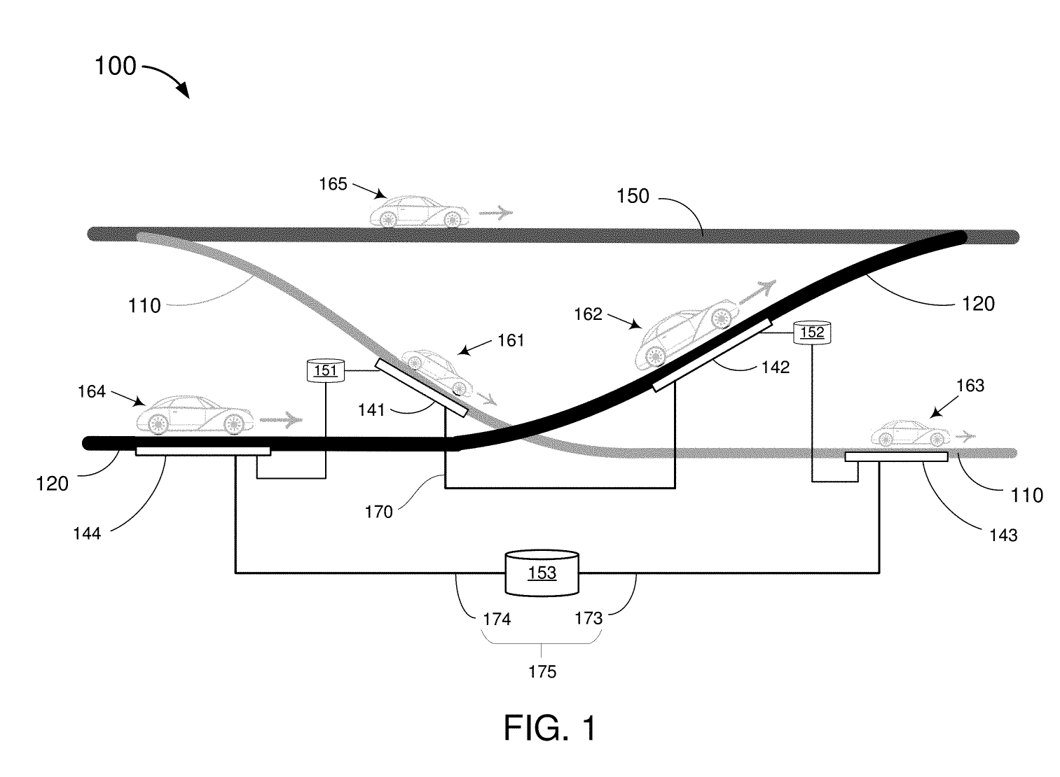

FIG. 1 illustrates an example energy recovery system 100 in accordance with an embodiment of the present disclosure. FIG. 1 shows a local road structure of a highway access that includes an exit ramp 110 and an entrance ramp 120. Exit ramp 110 leads vehicles such as vehicles 161 and 163 to get off highway 150, while entrance ramp 120 leads vehicles such as vehicle 164 and 162 to get on highway 150. Vehicles driving on exit ramp 110 are coming off highway 150, and thus most of them may perform a deceleration operation. Each of vehicles 161 and 163 is equipped with a regenerative braking apparatus, which enables the respective vehicle to recover braking energy during the deceleration process while driving on exit ramp 110.

Energy recovery system 100 includes charging pads 141 and 143, each of which may be placed on, buried under or embedded in the surface of exit ramp 110. In particular embodiments, charging pads 141 and 143 are made of a metal, alloy, or other conducting (or superconducting) material. In some embodiments, charging pads 141 and 143 include coils that are encased by a material that protects the charging pads from environmental elements, such as snow, rain, tire contact, wear caused by tire contact, and the like. The material encasing charging pads 141 and 143 will protect the coils without interfering with the inductive transfer of power. Charging pads 141 and 143 may be positioned substantially planar with the road surface. In alternate embodiments, charging pads 141 and 143 are positioned slightly below the road surface to reduce the likelihood of damage from snow plows and the like.

When vehicle 161 gets close to or on charging pad 141, it may be performing a deceleration operation, and electric power generated due to the deceleration by the regenerative braking apparatus equipped on vehicle 161 may be wireless transferred from vehicle 161 to charging pad 141. Similarly, when vehicle 163 gets close to or on charging pad 143, it may be performing a deceleration operation, and electric power generated due to the deceleration by the regenerative braking apparatus equipped on vehicle 163 may be wireless transferred from vehicle 163 to charging pad 143.

Energy recovery system 100 also includes charging pads 142 and 144, each of which may be placed on, buried under or embedded in the surface of entrance ramp 120. When vehicle 162 gets close to or on charging pad 142, it may be performing an acceleration operation that demands more electric power. Charging pad 142 may receive at least part of the electric power generated by vehicle 161 from charging pad 141 via transmission line 170, and then supply the electric power to vehicle 162 wirelessly for the acceleration operation. Similarly, when vehicle 164 gets close to or on charging pad 144, it may be performing an acceleration operation that demands more electric power. Charging pad 144 may receive at least part of the electric power generated by vehicle 163 from charging pad 143 via a first portion 173 of a transmission line 175, battery 153 and a second portion 174 of transmission line 175, and then supply the electric power to vehicle 164 wirelessly for the acceleration operation.

Energy recovery system 100 may also include one or more energy storage media such as batteries 151, 152 and 153 as shown in FIG. 1. The energy storage media are not limited to batteries; they may be electric capacitors or other media that can hold electric energy. As illustrated in FIG. 1, battery 151 is electrically coupled to charging pads 141 and 144, respectively. This enables the recovered electric energy received by charging pad 141 to be firstly stored in battery 151 and then subsequently (may be at a later time) transmitted, at least partially, from battery 151 to charging pad 144, in an event where vehicle 164 is on or near charging pad 144 and demands electric power. Similarly, battery 152 is electrically coupled to charging pads 142 and 143, respectively. This enables the recovered electric energy received by charging pad 143 to be firstly stored in battery 152 and then subsequently (may be at a later time) transmitted, at least partially, from battery 152 to charging pad 142, in an event where vehicle 162 is on or near charging pad 142 and demands electric power. By the same token, battery 153 is electrically coupled to charging pads 142 and 143 via transmission line 175, respectively. This enables the recovered electric energy received by charging pad 143 to be firstly stored in battery 153 and then subsequently (may be at a later time) transmitted, at least partially, from battery 153 to charging pad 144, in an event where vehicle 164 is on or near charging pad 144 and demands electric power.

Energy recovery system 100 may also include one or both of vehicle 161 and 163 that may contribute recovered brake energy to system 100 in the form of electric power, and may also include one or both of vehicle 162 and 164 that may receive at least a part of the recovered brake energy from system 100 in the form of electric power to charge their respective on-board batteries that provide the driving power of vehicles 162 and 164.

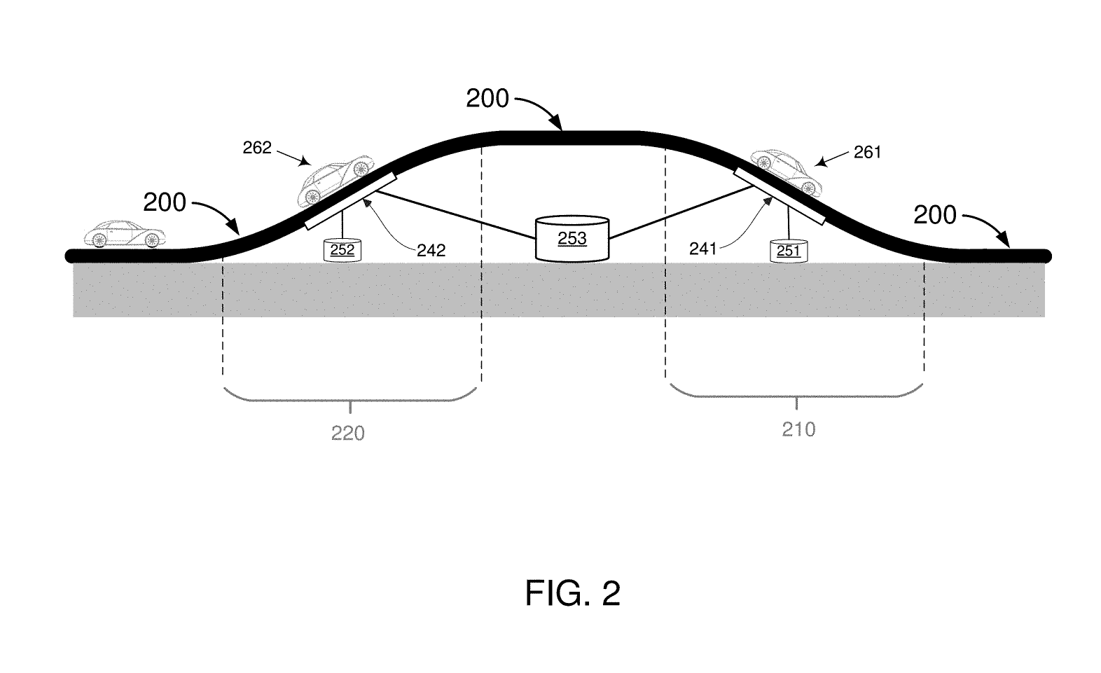

FIG. 2 illustrates another example energy recovery system in accordance with an embodiment of the present disclosure. FIG. 2 shows a local road structure, overpass 200, which includes upward ramp 220 where vehicle 262 is driving on, as well as downward ramp 210 where vehicle 261 is driving on. Typically, vehicles driving on upward ramp 220 are more likely to perform an acceleration operation than a deceleration operation, while vehicles driving on downward ramp 210 are more likely to perform a deceleration operation than an acceleration operation. Vehicle 261 is equipped with a regenerative braking apparatus configured to recover unwanted kinetic energy of vehicle 261 due to a deceleration operation while coming down downward ramp 210 of overpass 200. The recovered kinetic energy may be wireless transferred in the form of electric power from vehicle 261 to charging pad 241 through inductive power transfer. Charging pad 241 is electrically coupled to batteries 251 and 253, respectively, and battery 253 is electrically coupled to charging pad 242 such that a part of the electric power received by battery 253 from charging pad 241 may be transmitted to charging pad 242. Charging pad 242 is configured to charge an on-board battery of vehicle 262 when the vehicle is on or near charging pad 242, as vehicle 262 may demand power from the on-board battery for a possible acceleration operation driving on upward ramp 220 of overpass 200. Charging pad 242 may also be electrically coupled to battery or capacitor 252 and store electric power therein.

The example energy recovery system illustrated in FIG. 2 may include charging pads 241 and 242 disposed on downward ramp 210 and upward ramp 220, respectively, of overpass 200. The system may also include one or more of the batteries or capacitors 251, 252 and 253. The system may further include vehicles 261 and 262.

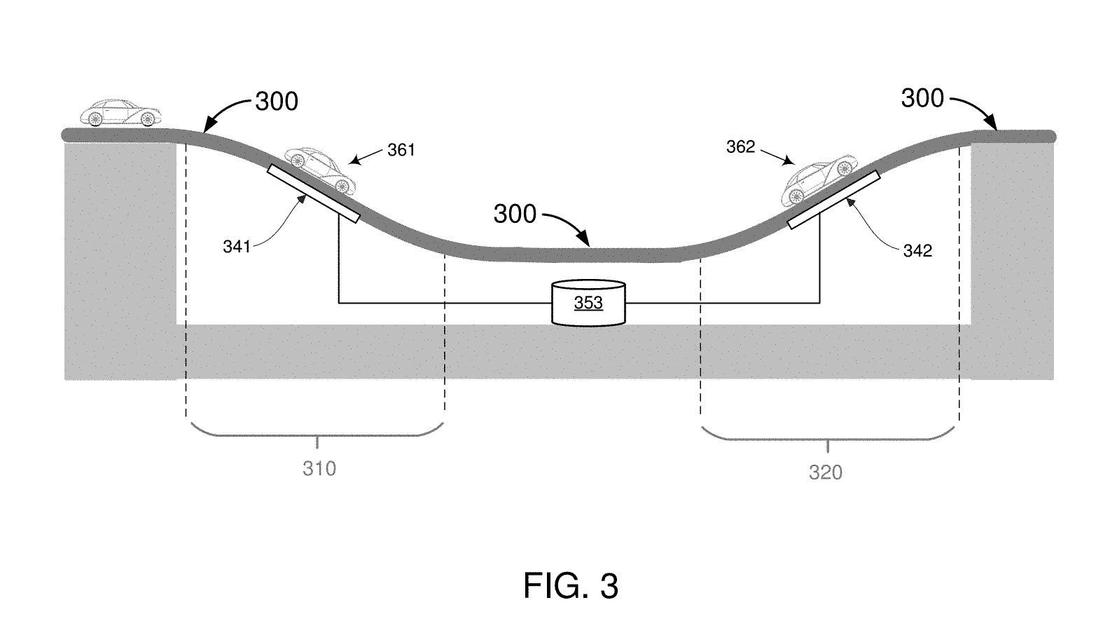

FIG. 3 illustrates yet another example energy recovery system in accordance with an embodiment of the present disclosure. FIG. 3 shows a local road structure, an underpass 300, which includes downward ramp 310 where vehicle 361 is driving on, as well as upward ramp 320 where vehicle 362 is driving on. Typically, vehicles driving on downward ramp 310 are more likely to perform a deceleration operation than an acceleration operation, while vehicles driving on upward ramp 320 are more likely to perform an acceleration operation than a deceleration operation. Vehicle 361 is equipped with a regenerative braking apparatus configured to recover unwanted kinetic energy of vehicle 361 due to a deceleration operation while coming down downward ramp 310 of underpass 300. The recovered kinetic energy may be wireless transferred in the form of electric power from vehicle 361 to charging pad 341 through inductive power transfer. Charging pad 341 is electrically coupled to battery 353, and battery 353 is electrically coupled to charging pad 342 such that a part of the electric power received by battery 353 from charging pad 341 may be transmitted to charging pad 342. Charging pad 342 is configured to charge an on-board battery of vehicle 362 when the vehicle is on or near charging pad 342, as vehicle 362 may demand power from the on-board battery for a possible acceleration operation driving on upward ramp 320 of underpass 300.

The example energy recovery system illustrated in FIG. 3 may include charging pads 341 and 342 disposed on downward ramp 310 and upward ramp 320, respectively, of underpass 300. The system may also include battery 353. The system may further include vehicles 361 and 362.

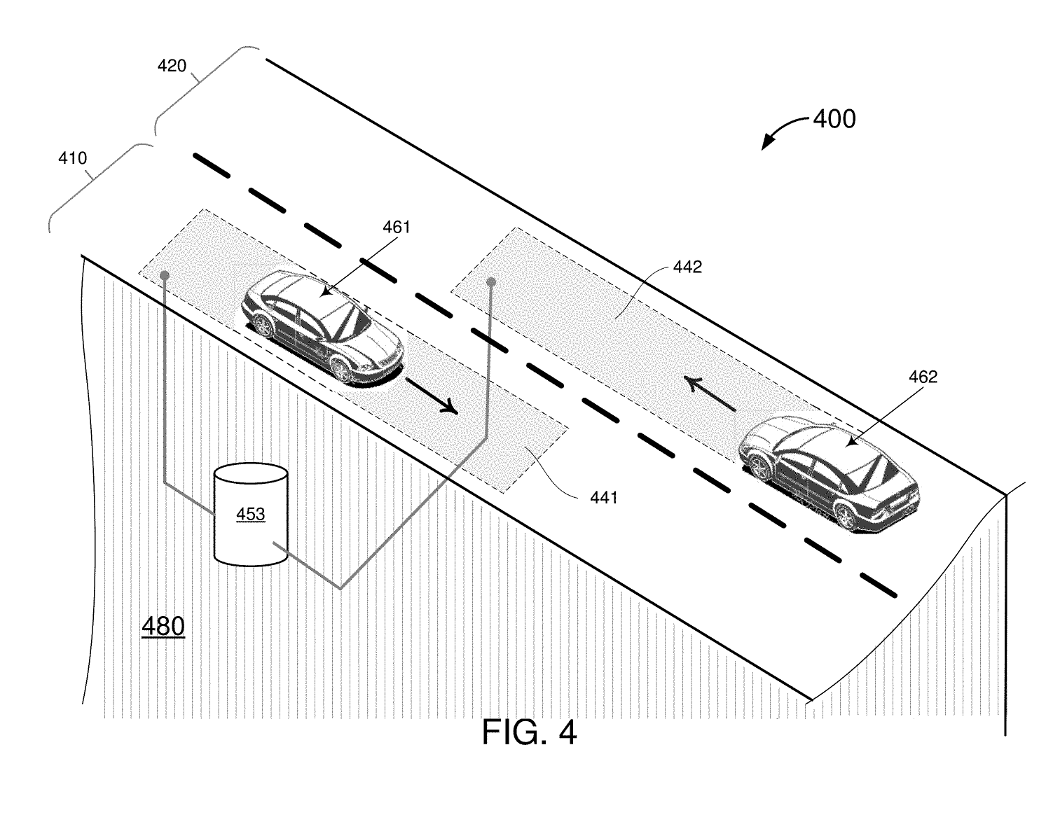

FIG. 4 illustrates still another example energy recovery system 400 in accordance with an embodiment of the present disclosure. FIG. 4 shows a local road structure, a two-way road section located on slope 480, which includes downhill lane 410 where vehicle 461 is driving on, as well as uphill lane 420 where vehicle 462 is driving on. Typically, vehicles driving on uphill lane 420 are more likely to perform an acceleration operation than a deceleration operation, while vehicles driving on downhill lane 410 are more likely to perform a deceleration operation than an acceleration operation. Vehicle 461 is equipped with a regenerative braking apparatus configured to recover unwanted kinetic energy of vehicle 461 due to a deceleration operation while coming down downhill lane 410 of the two-way road section. The recovered kinetic energy may be wireless transferred in the form of electric power from vehicle 461 to charging pad 441 through inductive power transfer. Charging pad 441 is electrically coupled to battery 453, and battery 453 is electrically coupled to charging pad 442 such that a part of the electric power received by battery 453 from charging pad 441 may be transmitted to charging pad 442. Charging pad 442 is configured to charge an on-board battery of vehicle 462 when the vehicle is on or near charging pad 442, as vehicle 462 may demand power from the on-board battery for a possible acceleration operation driving on uphill lane 420 of the two-way road section.

The example energy recovery system 400 may include charging pads 441 and 442 disposed on downhill lane 410 and uphill lane 420, respectively, of the two-way road section in FIG. 4. The system may also include battery 453. The system may further include vehicles 461 and 462.

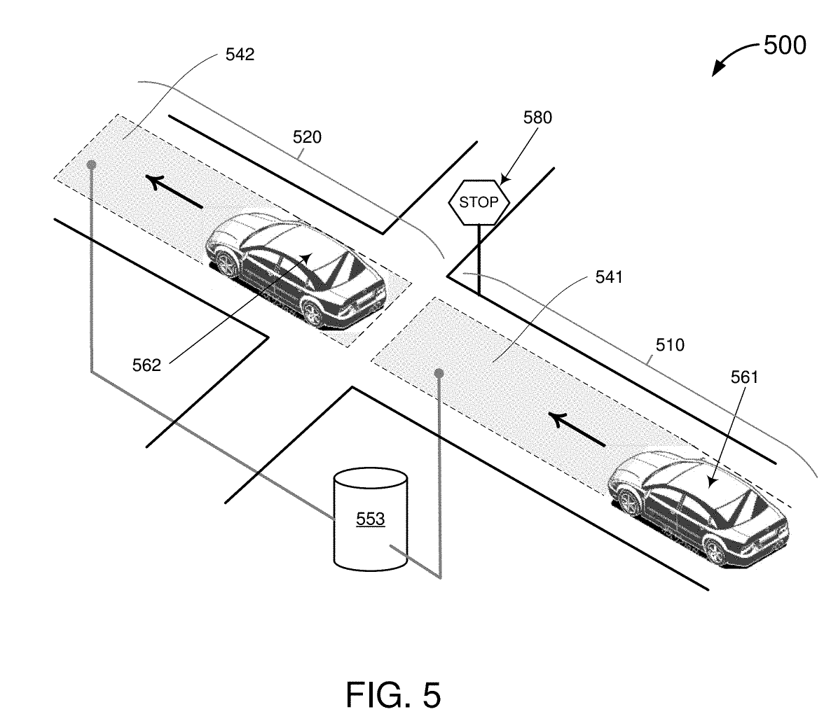

FIG. 5 illustrates another example energy recovery system 500 in accordance with an embodiment of the present disclosure. FIG. 5 shows a local road structure, a road section having stop sign 580. The road section having stop sign 580 includes first portion 510 of the road section before stop sign 580, where vehicle 561 is driving on. The road section having stop sign 580 also includes second portion 520 of the road section after stop sign 580, where vehicle 562 is driving on. Typically, vehicles driving on first portion 510 of the road section before stop sign 580 are more likely to perform a deceleration operation than an acceleration operation, while vehicles driving on second portion 520 of the road section after stop sign 580 are more likely to perform an acceleration operation than a deceleration operation. Vehicle 561 is equipped with a regenerative braking apparatus configured to recover unwanted kinetic energy of vehicle 561 due to the deceleration operation when vehicle 561 approaches stop sign 580. The recovered kinetic energy may be wireless transferred in the form of electric power from vehicle 561 to charging pad 541 through inductive power transfer. Charging pad 541 is electrically coupled to battery 553, and battery 553 is electrically coupled to charging pad 542 such that a part of the electric power received by battery 553 from charging pad 541 may be transmitted to charging pad 542. Charging pad 542 is configured to charge an on-board battery of vehicle 562 when the vehicle is on or near charging pad 542, as vehicle 562 may demand power from the on-board battery for a possible acceleration operation as vehicle 562 starts to move pass stop sign 580 after stopping at stop sign 580.

In some embodiments, vehicle 561 and vehicle 562 in FIG. 5 may be the same vehicle at two different moments. That is, a vehicle may be represented by numeral 561 in FIG. 5 as it approaches and then stops at stop sign 580, transmitting its recovered brake energy in a form of electric energy to charging pad 541, which in turn transmits at least part of the electric energy to battery 553 to be stored. As the vehicle moves again after the stop at stop sign 580, passing stop sign 580 and moving forward, the vehicle is represented by numeral 562 in FIG. 5. At this time while the vehicle is driving on second portion 520 of the road section after stop sign 580, an on-board battery of the vehicle is charged by charging pad 542 with electric power supplied by battery 553, providing the needed power for the vehicle to drive on.

A similar mechanism and operation as disclosed by energy recovery system 500 of FIG. 5 can apply for other similar embodiments such as in the case of a road section having a dip, a toll booth or a bus stop.

The example energy recovery system 500 may include charging pads 541 disposed in first portion 510 of the road section before stop sign 580. The example energy recovery system 500 may also include charging pads 542 disposed in second portion 520 of the road section after stop sign 580. The system may also include battery 553. The system may further include vehicles 561 and 562.

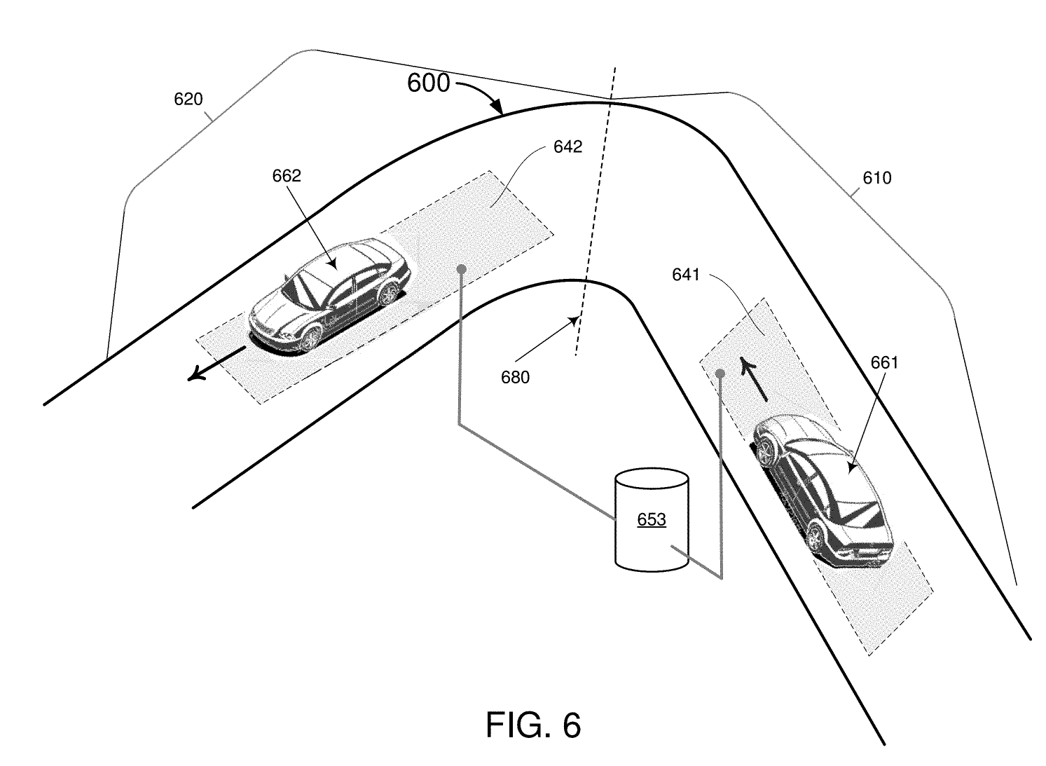

FIG. 6 illustrates yet another example energy recovery system in accordance with an embodiment of the present disclosure. FIG. 6 shows a local road structure, a road section with turn 600. The road section with turn 600 includes first portion 610 of the road section before middle point 680 of turn 600, where vehicle 661 is driving on. The road section with turn 600 also includes second portion 620 of the road section after middle point 680 of turn 600, where vehicle 662 is driving on. Typically, vehicles driving on first portion 610 of the road section before middle point 680 are more likely to perform a deceleration operation than an acceleration operation, while vehicles driving on second portion 620 of the road section after middle point 680 are more likely to perform an acceleration operation than a deceleration operation. Vehicle 661 is equipped with a regenerative braking apparatus configured to recover unwanted kinetic energy of vehicle 661 due to the deceleration operation when vehicle 661 approaches middle point 680. The recovered kinetic energy may be wireless transferred in the form of electric power from vehicle 661 to charging pad 641 through inductive power transfer. Charging pad 641 is electrically coupled to battery 653, and battery 653 is electrically coupled to charging pad 642 such that a part of the electric power received by battery 653 from charging pad 641 may be transmitted to charging pad 642. Charging pad 642 is configured to charge an on-board battery of vehicle 662 when the vehicle is on or near charging pad 642, as vehicle 662 may demand power from the on-board battery for a possible acceleration operation as vehicle 662 starts to move pass middle point 680 of turn 600 and drive on.

In some embodiments, vehicle 661 and vehicle 662 in FIG. 6 may be the same vehicle at two different moments. That is, a vehicle may be represented by numeral 661 in FIG. 6 as it approaches middle point 680 of turn 600, transmitting its recovered brake energy in a form of electric energy to charging pad 641, which in turn transmits at least part of the electric energy to battery 653 to be stored. As the vehicle moves again after passing middle point 680 of turn 600 and moving forward, the vehicle is represented by numeral 662 in FIG. 6. At this time while the vehicle is driving on second portion 620 of the road section after middle point 680, an on-board battery of the vehicle is charged by charging pad 642 with electric power supplied by battery 653, providing the needed power for the vehicle to drive on.

A similar mechanism and operation as disclosed by energy recovery system 500 of FIG. 5 can apply for other similar embodiments such as in the case of a highway cloverleaf interchange or a surface roundabout circular intersection.

The example energy recovery system illustrated in FIG. 6 may include charging pads 641 disposed in first portion 610 of the road section before middle point 680 of turn 600. The system may also include charging pads 642 disposed in second portion 620 of the road section after middle point 680 of turn 600. The system may also include battery 653. The system may further include vehicles 661 and 662.

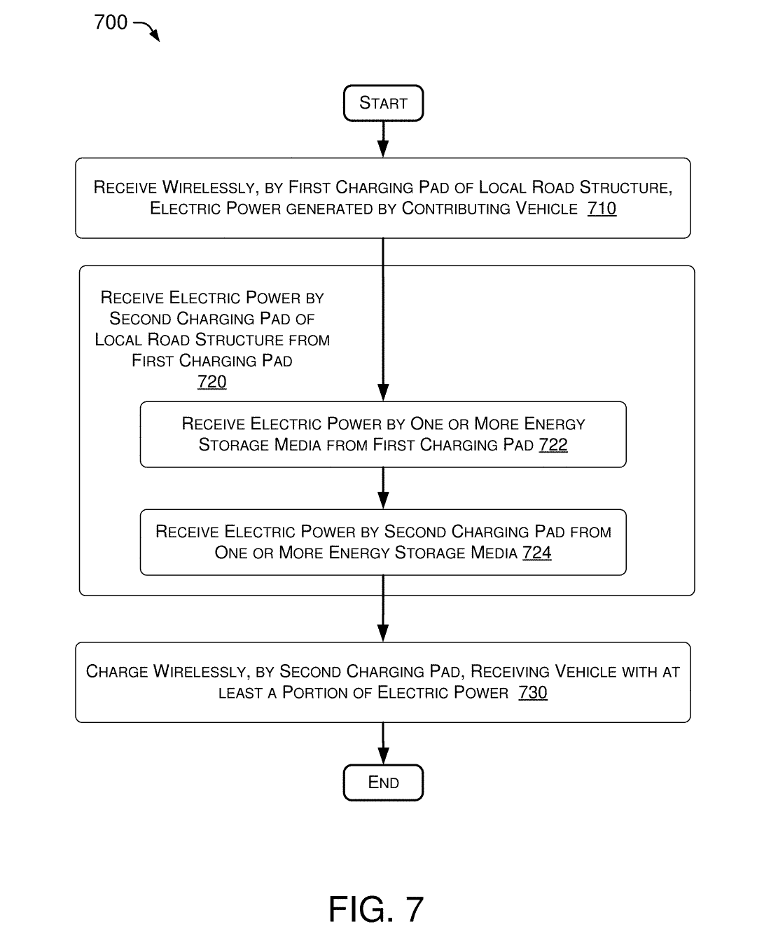

FIG. 7 illustrates an example process 700 in accordance with an embodiment of the present disclosure. Process 700 may include one or more operations, actions, or functions shown as blocks such as 710, 720 and 730 as well as sub-blocks 722 and 724. Although illustrated as discrete blocks, various blocks of process 700 may be divided into additional blocks, combined into fewer blocks, or eliminated, depending on the desired implementation. Process 700 may be implemented by any of energy recovery systems 100, 400 and 500 as well as energy recovery systems illustrated in FIGS. 2, 3 and 6. For simplicity of description and not limiting the scope of the present disclosure, process 700 is described below in the context of example energy recovery system 100. Process 700 may begin with block 710.

At 710, process 700 may involve charging pad 143 of a highway access wirelessly receiving an electric power generated by a regenerative braking apparatus of vehicle 163. Block 710 may be followed by block 720.

At 720, process 700 may involve charging pad 144 of the same highway access receiving the electric power from charging pad 143 via transmission line 175. This may involve operations performed at sub-blocks 722 and 724. At 722, process 700 may involve one or more energy storage media (e.g., battery 153) receiving the electric power from charging pad 143 via first portion 173 of transmission line 175. Sub-block 722 may be followed by sub-block 724. At 724, process 700 may involve charging pad 144 receiving the electric power from battery 153 via second portion 174 of transmission line 175. Sub-block 724 may be followed by block 730.

At 730, process 700 may involve charging pad 144 wirelessly charging vehicle 164 with at least a portion of the electric power generated by the regenerative braking apparatus of vehicle 163.

In some embodiments, in receiving the electric power by charging pad 144 from charging pad 143, process 700 may involve battery 153 receiving the electric power from charging pad 143 via first portion 173 of transmission line 175. Process 700 may also involve charging pad 144 receiving the electric power from battery 153 via second portion 174 of transmission line 175.

In particular embodiments, on-vehicle circuitry and software are used to generate electricity during deceleration and store the generated electricity. The on-vehicle circuitry and software may use the stored power during accelerations, changes in altitude, or overcoming aerodynamic drag, friction, and the like. Additionally, the on-vehicle circuitry and software may wirelessly transfer some of the power to a receiving element (i.e., charging pad) in the road surface.

In some embodiments, the described systems include circuitry and software that, similar to an electric utility grid, transmits power and temporarily stores power. Excess power can be distributed to a normal power grid. However, in some embodiments, the systems described herein are installed in areas where vehicles regularly accelerate and decelerate so the power generated during deceleration can be locally provided to other vehicles during acceleration. In particular embodiments, vehicles wirelessly communicate with the grid to advertise how much power the vehicle can contribute (i.e., transfer) to the grid and/or how much power the vehicle needs to receive (or is capable of receiving into its battery storage system).

In some embodiments, in receiving wirelessly the electric power generated by the regenerative braking apparatus of the contributing vehicle, process 700 may involve charging pad 143 receiving the electric power through inductive power transfer.

In some embodiments, in charging wirelessly the receiving vehicle with at least a portion of the electric power, process 700 may involve charging pad 144 charging a battery of the receiving vehicle with the electric power through inductive power transfer.

Numerous advantages are resulted according to the systems and methods according to the various embodiments of the present disclosure. The advantages include, at least, unlimited brake energy recovery due to off-vehicle storage batteries, longer sustainability and/or a smaller size of the on-board battery of the receiving vehicle, low power transmission loss due to short distance power transmission, and less wearing and longer life span of braking pads, just to name a few.

The articles “a” and “an” are used herein to refer to one or to more than one (i.e., to at least one) of the grammatical object of the article. By way of example, “a user” means one user or more than one users. Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code or the like), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Although the present disclosure is described in terms of certain embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A system comprising:
a first charging pad disposed at a first location of a road structure and configured to receive an electric power wirelessly from a contributing vehicle; and
a second charging pad disposed at a second location of the road structure and configured to receive the electric power from the first charging pad and charge a receiving vehicle wirelessly with at least a portion of the electric power.

2. The system of claim 1, wherein the first charging pad is disposed on, below or in a first portion of the road structure where more vehicles decelerate than accelerate, and wherein the second charging pad is disposed on, below or in a second portion of the road structure where more vehicles accelerate than decelerate.

3. The system of claim 2, wherein the road structure comprises a highway access, wherein the first portion of the road structure comprises an exit ramp of the highway access, and wherein the second portion of the road structure comprises an entrance ramp of the highway access.

4. The system of claim 2, wherein the road structure comprises an underpass or an overpass, wherein the first portion of the road structure comprises an downward ramp of the underpass or the overpass, and wherein the second portion of the road structure comprises an upward ramp of the underpass or the overpass.

5. The system of claim 2, wherein the road structure comprises a two-way road section located on a slope, wherein the first portion of the road structure comprises a downhill lane of the two-way road section, and wherein the second portion of the road structure comprises an uphill lane of the two-way road section.

6. The system of claim 2, wherein the road structure comprises a road section having a dip, a stop sign, a toll booth or a bus stop, wherein the first portion of the road structure comprises a portion of the road section before the dip, the stop sign, the toll booth or the bus stop, and wherein the second portion of the road structure comprises a portion of the road section after the dip, the stop sign or the toll booth.

7. The system of claim 2, wherein the road structure comprises a road section comprising a turn, wherein the first portion of the road structure comprises a portion of the road section before a middle point of the turn and wherein the second portion of the road structure comprises a portion of the road section after the middle point of the turn.

8. The system of claim 2, wherein the road structure comprises a highway cloverleaf interchange or a surface roundabout circular intersection.

9. The system of claim 1, further comprising:
one or more energy storage media configured to store at least a portion of the electrical energy, wherein each of the one or more energy storage media is electrically coupled to either or both of the first charging pad and the second charging pad.

10. The system of claim 9, wherein the one or more energy storage media comprise a battery or a capacitor, and wherein the battery or the capacitor is disposed within the road structure.

11. The system of claim 9, wherein the one or more energy storage media comprise a battery or a capacitor, and wherein the battery or the capacitor is disposed in a vicinity of the road structure.

12. The system of claim 1, further comprising the contributing vehicle, wherein the contributing vehicle comprises an electric vehicle, a hybrid electric vehicle or a non-electric vehicle, wherein the contributing vehicle is equipped with a regenerative braking apparatus, and wherein the electric power is generated via the regenerative braking apparatus of the contributing vehicle.

13. The system of claim 1, further comprising the receiving vehicle, wherein the receiving vehicle is equipped with a battery configured to be charged wirelessly with the at least a portion of the electric power by the second charging pad, and wherein the battery provides at least a portion of an electricity consumption of the receiving vehicle.

14. The system of claim 1, wherein the first charging pad is configured to receive the electric power wirelessly through inductive power transfer, and wherein the second charging pad is configured to charge the receiving vehicle wirelessly through inductive power transfer.

15. A method for recovering braking energy, the method comprising:
receiving wirelessly, by a first charging pad of a road structure, an electric power generated by a regenerative braking apparatus of a contributing vehicle;
receiving, by a second charging pad of the road structure, the electric power from the first charging pad via a transmission line; and
charging wirelessly, by the second charging pad, a receiving vehicle with at least a portion of the electric power.

16. The method for recovering braking energy of claim 15, wherein the receiving of the electric power from the first charging pad to the second charging pad comprises:
receiving the electric power by one or more energy storage media from the first charging pad to via a first portion of the transmission line; and
receiving the electric power by the second charging pad from the one or more energy storage media via a second portion of the transmission line.

17. The method for recovering braking energy of claim 16, wherein the one or more energy storage media comprise a battery or a capacitor, and wherein the battery or the capacitor is disposed within or in a vicinity of the road structure.

18. The method for recovering braking energy of claim 15, wherein the receiving wirelessly of the electric power generated by the regenerative braking apparatus of the contributing vehicle comprises receiving the electric power through inductive power transfer.

19. The method for recovering braking energy of claim 15, wherein the charging wirelessly of the receiving vehicle with at least a portion of the electric power comprises charging a battery of the receiving vehicle with the electric power through inductive power transfer.

20. The method for recovering braking energy of claim 15, wherein the first charging pad is disposed on, below or in a first portion of the road structure where more vehicles decelerate than accelerate, and wherein the second charging pad is disposed on, below or in a second portion of the road structure where more vehicles accelerate than decelerate.
